(19) United States
(12) Patent Application Publication
(10) Pub. No.: US 2007/0263544 A1
(43) Pub. Date: Nov. 15, 2007

(54) System and method for finding shortest paths between nodes included in a network

(75) Inventors: Naoaki Yamanaka, Tokyo (JP); Hiroyuki Ishikawa, Kanagawa (JP); Yutaka Arakawa, Kanagawa (JP); Sho Shimizu, Kanagawa (JP); Kosuke Shiba, Saitama (JP)

Correspondence Address: MARSHALL, GERSTEIN & BORUN LLP, 233 S. WACKER DRIVE, SUITE 6300, SEARS TOWER, CHICAGO, IL, 60606, US

(73) Assignees: IPFLEX INC., Tokyo (JP); KEIO UNIVERSITY, Tokyo (JP)

(21) Appl. No.: 11/603,995

(22) Filed: Nov. 21, 2006

(30) Foreign Application Priority Data
May 15, 2006 (JP) 2006-134639

(51) Int. Cl. G08C 15/00

(52) U.S. Cl. 370/238; 370/252

(57) ABSTRACT

There is provided a system that uses a network matrix to carry out a search for shortest paths from a starting node included in a network having a plurality of nodes to other nodes. The network matrix includes link costs of links and each link has a root end that is a node included in the network and a tail end that is another node connected to the root end. The system includes a processor that includes a circuit for subtracting a lowest value from link costs of the subject links being searched that are included in the network matrix, a circuit for setting tail end node of a link out of the subject links whose link cost has become zero due to the subtracting as a reached node, a circuit for changing link costs of links included in the network matrix whose tail end nodes are the reached node to a value indicating exclusion from further search, and a circuit for setting values after the subtracting of link costs of the subject links whose link costs do not become zero due to the subtracting as link costs of links for a continued search.

### CROSS-REFERENCE TO RELATED APPLICATIONS

This application is based upon and claims the benefit of priority from the prior Japanese Patent Application No. 2006-134639, filed May 15, 2006, the entire contents of which are incorporated herein by reference.

### TECHNICAL FIELD

The present invention relates to speeding up finds shortest paths on a network.

### BACKGROUND

The explosive development and expansion of the Internet has led to computer networks becoming used frequently in both work and everyday life. On a computer network, a routing table is generated based on information exchanged using a routing protocol and packets are transmitted in accordance with the routing table. With OSPF (Open Shortest Path First) that is a typical routing protocol, a routing table is generated using an algorithm called Dijkstra's algorithm for finding shortest paths.

A specific example of Dijkstra's algorithm will now be described with reference to FIGS. 1A to 1D. Dijkstra's algorithm is an algorithm for finding shortest paths from a starting node to all other nodes. Each node has two pieces of information, that is, the immediately preceding node and distance. In FIGS. 1A to 1D, a, b, c, and d are nodes and the values given between nodes represent link costs. First, the distance Da of the starting node a is set at zero, and the distances Db to Dd of the other nodes are set at infinite. Next, the other nodes adjacent to node a are investigated in order, and values produced by adding the link costs from node a to the distance Da (which equals zero) of node a are set as provisional distances (see FIG. 1A).

Next, the path to node c, which has the shortest distance out of all of the nodes that have been appended with provisional distances, is decided. At this point, node d is set as a provisional path when advancing via node c and the provisional distance of node d is determined (see FIG. 1B).

At this stage, the distance Db of node b is four and the distance Dd of node d is six. For this reason, the path to node b is decided next. At this point, the provisional distance of node d when passing node b is determined (see FIG. 1C).

The shortest distance Dd of node d is updated to six when node c is passed, thereby determining the shortest path to node d (see FIG. 1D). In this way, if a new path is found by determining the shortest distance of a node, the distance is updated to the shortest value. That is, when a new path is shorter than an existing path, the distance to the node is updated. In this way, the distance of each node is updated as necessary, thereby setting the shortest out of the provisional distances as the shortest path of a node.

A method of determining the shortest distance using Dijkstra's algorithm on a network having n nodes is normally carried out as follows. First, a link graph G=(V,E) for nodes 1 to n and links (i,j) with link costs cᵢⱼ is generated and the shortest paths from node 1 to nodes 2 to n are determined. In Dijkstra's algorithm, each node has information of a temporary distances tDj and a determined distance Di (where i=1 to n) and the shortest out of the temporary distances of nodes is set as the shortest path. The algorithm is carried out as follows.

### Step 1

For the starting node 1, the determined distance D1=0. The temporary distance is set at tDj=cᵢⱼ (=infinity when there is no (1, J) link in the link graph G) for each node j (where j=2 to n). The group of nodes for which the shortest path has been determined is set as N. At this point, N=“1”.

### Step 2

In the group tN of nodes for which the shortest distances are yet to be determined, k, which is the shortest among the temporary distances tDk, is found and Dk is set equal to tDk. When there is a plurality of shortest temporary distances tDk, the lowest-numbered node k is taken and the node k is added to the group N. If group N=V (i.e., if tN=0), D2 to Dn are outputted, thereby completing the process. If not, the process proceeds to step 3.

### Step 3

tDj=min(tDj,Dk+cₖⱼ) is set for every node j remaining in the group tN. After this, the process returns to step 2.

The routing of packets on an IP network is carried out by the routers passed by such packets referring to routing tables stored within the routers. NHRs (Next Hop Router) with destination network addresses are recorded in the routing table and packets are transferred to the NHR that corresponds to the network address selected using longest match principle with the destination address of the packets. By having each router repeat the operations described above, the packets are transferred to their destination.

A routing table is generated based on the results of calculating the shortest paths. This means that if networks increase in scale as the Internet continues to expand, there is an increase in the load of the process that finds shortest paths, which can become a bottleneck. As the number of mobile terminals increases, it becomes necessary to update routing tables more often. Also, as ubiquitous computing spreads, it is believed that all kinds of products and/or goods will be assigned IP addresses using RFID (Radio Frequency Identification) tags and the like. When IP addresses are assigned to all kinds of objects, a huge number of IP addresses become necessary, and the number of addresses available for the currently used IPv4 protocol that has a 32-bit address space is insufficient. For this reason, to solve the problem of insufficient addresses, IPv6 with an address space expanded to 128 bits has been proposed. Accordingly, a routing method suited to networks including a huge number of appliances with IP addresses is required.

For optical networks, there have been proposals in recent years to calculate the link costs of links based not only on the speed of the links but also on a plurality of factors, such as the probability of successfully carrying out wavelength reservation. Since link costs fluctuate due to factors such as the number of users using the links and the types of data that pass the links, the routing table should preferably be updated to reflect the fluctuations in such factors. Accordingly, the load of calculating paths is likely to increase further.

Japanese Laid-Open Patent Publication No. 2004-32569 proposes having dedicated apparatuses for carrying out the process that calculates the shortest paths provided separately to routers. This method uses a larger amount of hardware but reduces the load of routers in calculating paths. However, there is no decrease in the load of calculating itself for obtaining paths for routing purposes.

Dijkstra's algorithm is a simple algorithm and is presently in widespread use since it is suited to the processing of a sequential processor like program counter based CPU. There is a problem however in that the number of calculations with Dijkstra's algorithm for a number n of nodes is O(n²), which means there is a large increase in the calculation load as the number of nodes increases.

Japanese Laid-Open Patent Publication No. 2001-308912 discloses the calculation of paths on a hierarchical QOSPF network. Routing information for within an area including a backbone and the like is provided from an area boundary router as compressed routing information. However, even if the areas that can be passed on the way to a destination node can be understood from such compressed routing information, in some conditions, such as when a plurality of routes are present within any of such areas, to calculate the shortest path, it will be necessary to carry out recalculation for all of the nodes inside such areas. If the network were converted into hierarchical networks (layered) and paths to be used for routing were then calculated, it would become possible to use distributed processing, which may be one method of reducing the load of calculating paths. However, to calculate the shortest paths between all points using Dijkstra's algorithm, the required number of calculations is further multiplied by n, resulting in a calculation load of O(n³). Accordingly, it is not possible to reduce the load of the calculation carried out for routing.

### SUMMARY

A first aspect of the present invention is a system (a “first system”) for searching for, using a network matrix, shortest paths from a starting node to other nodes. The starting node and the other nodes are included in a network that has a plurality of nodes. The network matrix includes link costs of links (direct connections). Each link has a root end that is a node included in the network and a tail end that is another node connected to the root end node.

The first system includes a processor for configuring a plurality of circuits in the processor, the plurality of circuits including circuits for:

subtracting a first value from link costs of subject links for a search that are included in the network matrix;

setting a tail end node of a link out of the subject links whose link cost has become zero due to the subtracting as a reached node;

changing link costs of links included in the network matrix whose tail end nodes are the reached node to a value indicating exclusion from further search; and

setting values after the subtracting of link costs of the subject links whose link costs do not become zero due to the subtracting as link costs of links for a continued search.

The first system also includes:

means for initially inputting, into the processor, link costs of links included in the network matrix and whose root end nodes are the starting node as the link costs of the subject links; and

means for reinputting, into the processor, the link costs of the links for the continued search and link costs of links, whose root end nodes are the reached node, included in the network matrix as the link costs of the subject links.

The means for initially inputting and the means for reinputting may be realized by circuits included or not included in the processor, or may be realized by software worked on a processor of program counter base.

The first system finds a node at the smallest distance by a simple parallel calculation, i.e., subtraction. Accordingly, it is possible to reduce the processing time by using a processor including a large number of parallel processing elements. The plurality of circuits configured in the processor should preferably include a circuit for finding a lowest value among the link costs of the subject links under the search as the first value. The first value may alternatively be a lowest unit for expressing the link costs included in the network matrix.

The first system should preferably also include a first function for obtaining the shortest paths from the starting node to the other nodes by repeating the reinputting into the processor (the circuits configured in the processor) until every other node that can be reached from the starting node has been set as a reached node. When the circuit configured on the processor includes a circuit for finding a lowest value out of the link costs of the subject links as the first value, the first function can obtain the shortest paths by repeating the reinputting into the processor a number of times equal to the number of other nodes for the starting node that are included in the network.

The first function may include repeating the initial inputting into the processor (the circuits configured on the processor) with all of the nodes included in the network as the starting node to obtain shortest paths that arrive the other nodes from every node included in the network.

Another aspect of the present invention is a system (a “second system”) for finding lowest costs from the starting node to the other nodes included in the network. The second system includes the first system equipped with the first function described above and a second function for obtaining lowest costs from the starting node to the other nodes by calculating using shortest paths obtained by the first function and the link costs included in the network matrix.

The second function may further includes obtaining shortest paths that have all of the nodes included in the network as the starting node and obtaining lowest costs from every node to other nodes that are included in the network. By obtaining the lowest cost from each node included in one network to each other node, it is possible to extract the lowest cost from nodes (boundary nodes) that make links of connections to other networks to the other node in the network. By using the extracted costs, it is possible to reduce (compress) the information on the paths that pass through the networks. Accordingly, by obtaining the lowest costs, it is possible to generate a higher-level network matrix that is a collection of boundary nodes.

Further one of aspects of the present invention is a system (a “third system”) including: the second system that is equipped with the second function described above; and a third function for obtaining a shortest path from a source node to a destination node, the source node and the destination node being included in a subject network to be analyzed that has n nodes. In the third system, the plurality of circuits configured on the processor are capable of processing the link costs of the subject links associating with a maximum of m nodes. The third function includes:

dividing the subject network into a plurality of networks on a lowest level, each of which has a maximum of m nodes;

generating at least one network on a higher level that has a maximum of m boundary nodes, the boundary nodes making links for connecting at least two networks out of a plurality of networks on a lower level;

generating a lowest level network matrix for each of the plurality of networks on the lowest level;

obtaining a lowest cost from each node to each other node in each of the plurality of networks on the lowest level using the second function and the lowest level network matrix;

generating a higher level network matrix for each higher level network, the higher level network matrix including lowest costs from a boundary node to other boundary nodes as link costs; and

obtaining, for the higher level networks, lowest costs from each boundary node to each other boundary node using the second function and the higher level network matrix, with each boundary node as the starting node.

The third function works as a function for converting the subject network to be analyzed into hierarchical networks and as a function for searching for a shortest path using the hierarchical networks.

By converting the network to hierarchical networks, it is possible to obtain shortest paths for a large-scale network using limited hardware resources including elements that carry out a simple operation, i.e., subtraction.

The third function should preferably further include: calculating, for each of a plurality of paths from the source node to the destination node via a plurality of the boundary nodes included in the higher-level network, a total of (i) a lowest cost from the source node to the boundary node in a network having the source node out of the plurality of lowest level networks, (ii) a lowest cost between boundary nodes included in the higher level network, and (iii) a lowest cost from a boundary node included in a network having the destination node out of the plurality of lowest level networks to the destination node; and obtaining a path with a lowest total of the lowest costs. By using the lowest costs between nodes (which include lowest costs between boundary nodes) obtained on the various levels, it is possible to determine shortest paths that have nodes included in the subject network to be analyzed as destination nodes.

One example of the third system is a router including a routing unit that is connected to a computer network. The routing unit is equipped with function of:

selecting a next hop to which a packet is to be transmitted based on a routing table; and

updating the routing table using the third function with obtaining information on a computer network that has the next hop using a routing protocol and recognizing the computer network as the subject network to be analyzed.

Further one of aspects of the present invention is a method that uses a processor whose circuits can be reconfigured and includes a first process for searching for shortest paths from a starting node to other nodes in a network. The first process includes:

obtaining a network matrix including link costs of links, each link having a root end that is a node included in the network and a tail end that is another node connected to the root end node; and

configuring a plurality of circuits in the processor.

The plurality of circuits include circuits for:

subtracting a first value from link costs of subject links for a search that are included in the network matrix;

setting a tail end node of a link out of the subject links whose link cost has become zero due to the subtracting as a reached node;

changing link costs of links included in the network matrix whose tail end nodes are the reached node to a value indicating exclusion from further search; and

setting values after the subtracting of link costs of the subject links whose link costs do not become zero due to the subtracting as link costs of links for a continued search.

The first process also includes:

initially inputting, into the processor (configured circuits on the processor), link costs of links included in the network matrix and whose root end nodes are the starting node as the link costs of the subject links; and

reinputting, into the processor (configured circuits on the processor), the link costs of the links for the continued search and link costs of links, whose root end nodes are the reached node, included in the network matrix as the link costs of the subject links.

Yet another aspect of the present invention is a method comprising, using a processor in which the plurality of circuits described above are configured, searching (the “first process”) for shortest paths from a starting node to other nodes in a network. This method also uses a network matrix including link costs of links.

The first process (step of searching for the shortest paths) includes the steps described below.

1.1 Initially inputting, into the processor (configured circuits in the processor), link costs of links included in the network matrix and whose root end nodes are the starting node as the link costs of the subject links under the search.

1-2 Reinputting, into the processor (configured circuits in the processor), the link costs of the links for the continued search and link costs of links, whose root end nodes are the reached node, included in the network matrix as the link costs of the subject links.

The first process (the step of searching for the shortest paths) should preferably also include the step described below.

1-3 Obtaining the shortest paths from the starting node to the other nodes by repeating the reinputting into the processor until every other node reachable from the starting node has been set as a reached node.

The processor should preferably include a circuit for finding a lowest value out of the link costs of the subject links under the search as the first value, and in step 1-3 of the first process that obtains the shortest paths, reinputting into the processor should preferably be repeated a number of times equal to the number of other nodes for the starting node that are included in the network.

The first process (the step of searching for the shortest paths) should preferably also include the step described below.

1-4 Repeating the initial inputting into the processor with all of the nodes included in the network as the starting node to obtain shortest paths that reach the other nodes from every node included in the network.

Another aspect of the method included in the present invention includes finding lowest costs from a starting node to others node included in a network (i.e., a second process). The second process (the step of finding the lowest cost) includes the steps described below.

2-1 Obtaining shortest paths using the first process (the step of searching for the shortest paths).

2-2 Obtaining lowest costs by calculation using the shortest paths and the link costs included in the network matrix.

The second process should preferably also include the step described below.

2-3 Obtaining shortest paths that have all of the nodes included in the network as the starting node and obtaining lowest costs from the nodes included to other nodes that are in the network.

Yet another method included in the present invention includes obtaining a shortest path from a source node to the destination node (a “third process”). The source node and the destination node are in a subject network to be analyzed that includes n nodes. When the circuits configured in the processor are capable of process link costs associating with a maximum of m nodes, the third process includes the steps described below.

3-1 Dividing the subject network into a plurality of networks on a lowest level, each of which has a maximum of m nodes.

3-2 Generating at least one network on a higher level that has a maximum of m boundary nodes, the boundary nodes making links for connecting at least two networks out of a plurality of networks on a lower level.

3-3 Generating a lowest network matrix for each of the plurality of networks on the lowest level.

3-4 Obtaining the lowest cost from each node to each other node in each of the plurality of network on the lowest level using the second process (the step of finding the lowest costs) and the lowest level network matrix.

3-5 Generating a higher level network matrix for each higher level network, the higher level network matrix including lowest costs from a boundary node to other boundary nodes as link costs.

3-6 Obtaining, for the higher level networks, lowest costs from each boundary node to each other boundary node using the second process (the step of finding the lowest costs) and the higher level network matrix, with each boundary node as the starting node.

The third process should preferably also include the step described below.

3-7 Calculating, for each of a plurality of paths from the source node to the destination node via a plurality of the boundary nodes included in the higher-level network, a total of (i) a lowest cost from the source node to a boundary node in a network including the source node out of the plurality of lowest level networks, (ii) a lowest cost between boundary nodes included in the higher level network, and (iii) a lowest cost from a boundary node included in a network including the destination node out of the plurality of lowest level networks to the destination node.

3-8 Obtaining a path with a lowest total of the lowest costs.

One of other aspect of the method included in the present invention is a process of selecting a next hop that is connected to a computer network. The process includes the steps described below.

4-1 Selecting a next hop to which a packet is to be transmitted based on a routing table.

4-2 Obtaining information on a computer network that has the next hop using a routing protocol, recognizing the computer network as the subject network to be analyzed, obtaining the shortest path from the source node to the destination node according to the third process described above, and updating the routing table.

Further one of aspects of the method included in the present invention is a method of searching for shortest paths from a starting node to other nodes included in a network having plurality of nodes. The method includes providing a network matrix including link costs of links, each of which has a root end that is a node included in the network and a tail end that is another node connected to the root end node. The method further includes the steps described below.

a1 Subtracting a first value from link costs of subject links for a search that are included in the network matrix.

a2 Setting a tail end node of links out of the subject links whose link cost has become zero due to the subtraction as a reached node.

a3 Changing link costs of links included in the network matrix whose tail end nodes are the reached node to a value indicating exclusion from further search.

a4 Setting values after the subtracting of link costs of the subject links whose link costs do not become zero due to the subtracting as link costs of links for a continued search and returning to the step of subtracting (the step al) with the link costs of the links for the continued search and link costs of links, whose root end nodes are the reached node, included in the network matrix, as the link costs of the subject links.

In the step al of subtracting, the lowest cost out of the link costs of the subject links should preferably be set as the first value. Alternatively, in the step al of subtracting, the lowest unit for the link costs in the network matrix may be set as the first value.

### BRIEF DESCRIPTION OF THE DRAWINGS

FIGS. 1A to 1D are schematic diagrams for explaining Dijkstra's algorithm;

FIG. 2A shows an arrangement of a network that has node A as the starting node,

FIG. 2B shows a network matrix, and

FIG. 2C shows a path matrix;

FIG. 3A shows the network in a state where node C has been reached,

FIG. 3B shows the network matrix, and

FIG. 3C shows the path matrix;

FIG. 4A shows the network when searching for the next node,

FIG. 4B shows the network matrix, and

FIG. 4C shows the path matrix;

FIG. 5A shows the network in a state where node B has been reached,

FIG. 5B shows the network matrix, and

FIG. 5C shows the path matrix;

FIG. 6A shows the network when searching for the next node,

FIG. 6B shows the network matrix, and

FIG. 6C shows the path matrix;

FIG. 7A shows the network in a state where node D has been reached,

FIG. 7B shows the network matrix, and

FIG. 7C shows the path matrix;

FIG. 8A shows the network in a state where the search has finished,

FIG. 8B shows the network matrix, and

FIG. 8C shows the path matrix;

FIGS. 9A to 9D show how a lowest cost matrix is generated;

FIG. 10A shows an arrangement of a different network,

FIG. 10B shows a network matrix, and FIG. 10C shows a path matrix;

FIG. 11 schematically shows an arrangement of a router;

FIG. 12 schematically shows a reconfigurable processor;

FIG. 13 schematically shows an arrangement of a PE included in the processor shown in FIG. 12;

FIG. 14 shows a state where circuits are configured in the processor shown in FIG. 12;

FIG. 15 shows a data format for inputting a network matrix;

FIG. 16 shows how the network matrix is converted to data for input;

FIG. 17 shows how pipeline processing is carried out by the processor shown in FIG. 12;

FIG. 18 is a flowchart showing a process of a first system;

FIG. 19 is a flowchart showing a process of a second system;

FIG. 20 shows how a network is converted into hierarchical networks;

FIG. 21 shows a simplified hierarchical structure for explaining the present invention;

FIGS. 22A to 22G show how a shortest path is found in the hierarchical networks shown in FIG. 21;

FIG. 23 is a flowchart showing a process of a third system;

FIG. 24 shows the number of groups generated by the conversion to hierarchical networks; and

FIG. 25 is a graph for evaluating performance, where the horizontal axis shows the number of nodes and the vertical axis shows calculation time (the number of cycles).

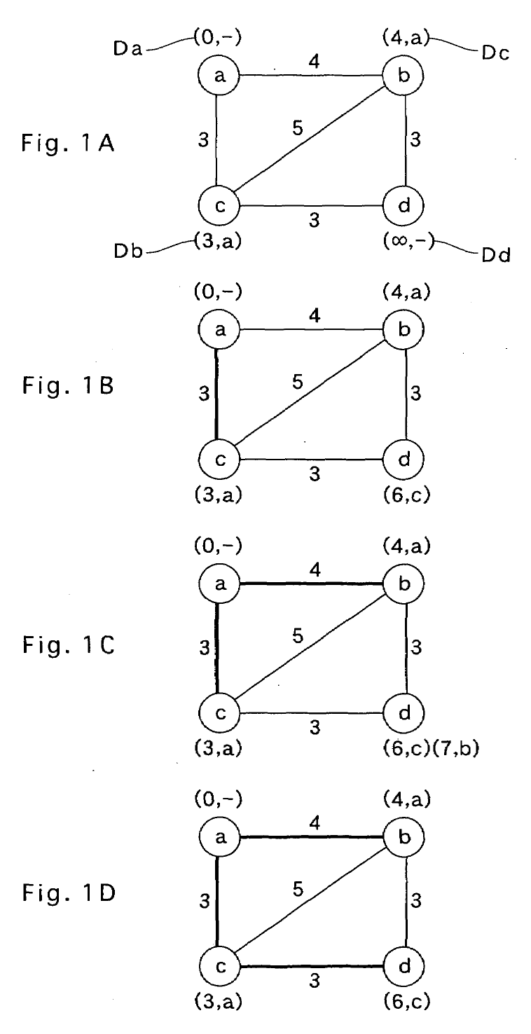

### DETAILED DESCRIPTION

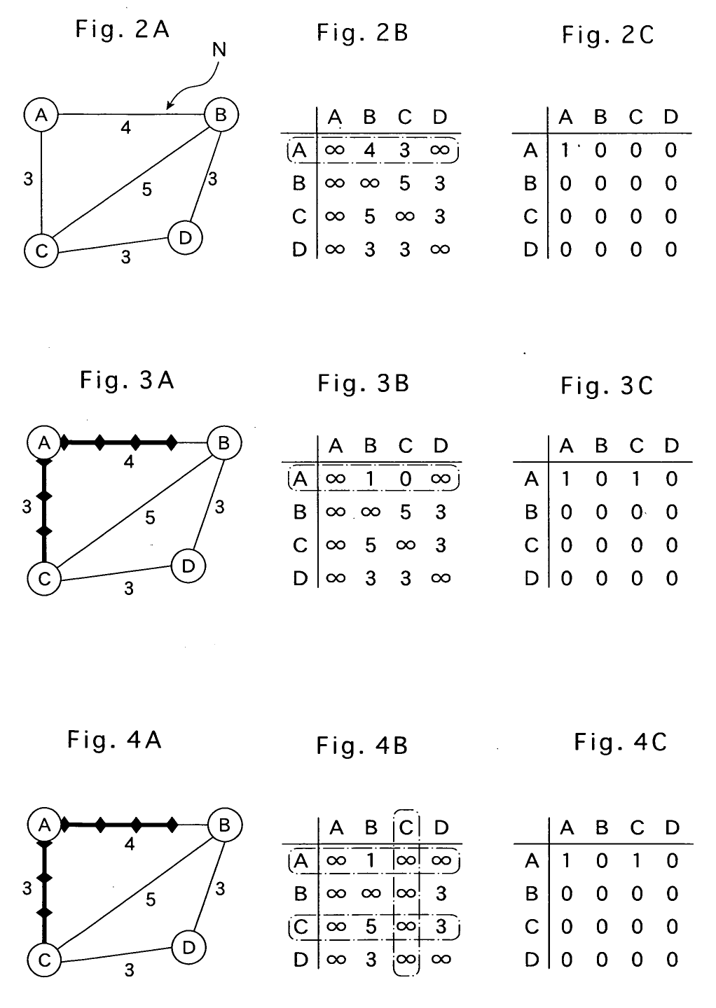

FIGS. 2A to 8C show how a shortest path is found by an algorithm included in the present invention. FIG. 2A shows a network N having four nodes A to D. FIG. 2B shows a network matrix MN including the costs of the respective links in the network N. On a computer network such as the Internet, a representative factor for determining the costs (link costs) between nodes is the reciprocal of the communication speed. It is also possible to reflect a plurality of factors, such as the success rate of wavelength reservation on an optical network, the type of data being transmitted, and the bandwidth reserved by QoS, in such link costs.

The elements of the network matrix MN are the costs of links (link costs). Each link has a root end that is a node included in the network N and a tail end that is another node directly connected to the root end node. In this example, the cost (link cost) of a link AB that has node A as the root end node and node B as the tail end node is four, the cost of a link AC that has node A as the root end node and node C as the tail end node is three, the cost of a link BC that has node B as the root end node and node C as the tail end node is five, the cost of a link BD that has node B as the root end node and node D as the tail node is three, and the cost of a link CD that has node C as the root end node and node D as the tail end node is three. Since other elements in the network matrix MN are not directly connected, the link costs of such elements are set at infinity in this example to exclude such elements (link costs) from searches. Depending on the system used for the search, the value indicating that elements are to be excluded from the search is not limited to infinity.

An example of searching for shortest paths from node A as a starting node to other nodes will now be described. Since the links BA, CA, and DA that have node A as the tail end node are to be excluded from the search, the costs of such links are set in advance at infinity. In addition, since the links AA, BB, CC, and DD do not exist, such link costs are also set at infinity.

FIG. 2C shows a path matrix MR that shows links for which a search has been completed. The path matrix MR also has a function for showing nodes that have been reached by a path search and the root end nodes for links being under the search. Accordingly, element relating node A that is the starting node is assigned the flag “1” showing that node A has been reached.

An example of searching for shortest paths using the algorithm including steps a1 to a4 described above will now be described for the network matrix MN. First, as shown in FIGS. 2A to 2C, the link costs of links that have node A (the starting node) as their root end node are selected as the link costs of the links to be searched (subject links). Next, as shown in FIG. 3B, the lowest cost (lowest value) among such link costs (i.e., three) is subtracted from the link cost of the subject links so that the cost of the link AC becomes zero (step a1).

In this algorithm, the tail end node of a link out of the subject links being searched whose link cost becomes zero due to the subtraction is a “reached node”. Accordingly, as shown in FIG. 3C, the reached flag “1” is assigned to the element AC in the path matrix MR (step a2).

Out of the link costs included in the network matrix MN, the link costs of links whose tail end nodes are the reached node are changed to the value indicating that such link costs are to be excluded from further search. As shown in FIG. 4B, the link costs of the links AC, BC, and DC that have the reached node C as their tail end nodes are set at infinity to indicate that such link costs are to be excluded from searches (step a3).

Out of the link costs produced after subtraction, the values aside from zero (where zeros indicate reached node or nodes) indicate links to be subjected to a continued search. In addition, the link costs of links that have reached nodes as their root end nodes are added as links to be searched. Accordingly, in this example, the link costs of links that have node A or node C, which have been assigned the reached node flag “1” in the path matrix MR, as their root end nodes are the costs of the links subjected to the next search.

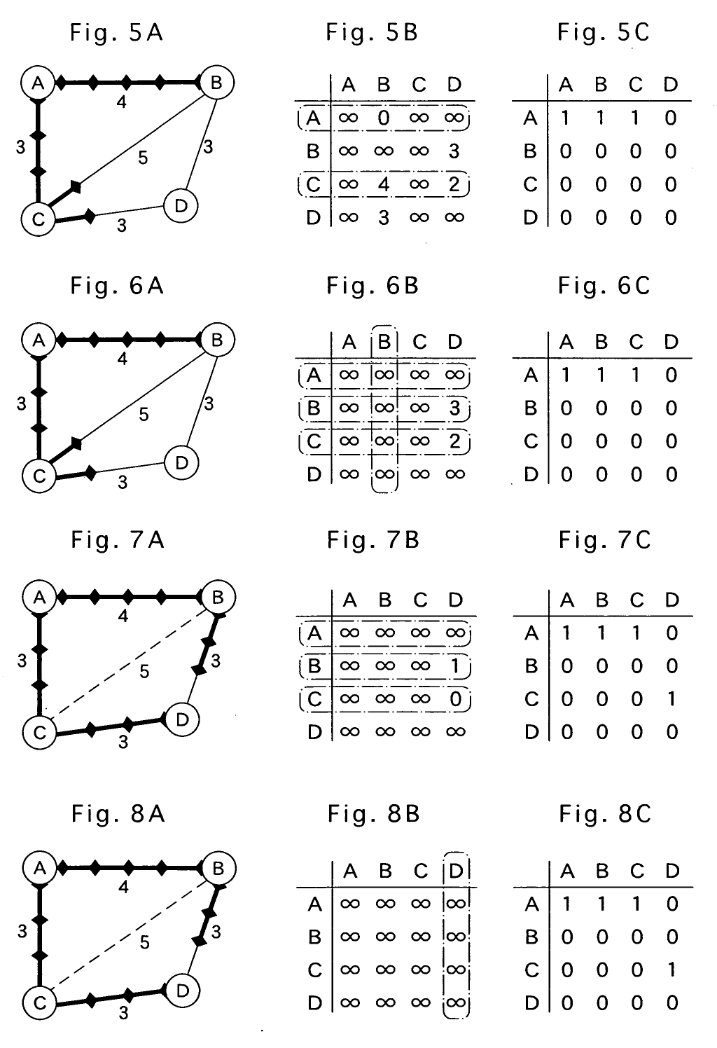

Next, the lowest value “1” out of the link costs of the subject links for the next search is subtracted from the link costs. As a result, as shown in FIG. 5B, the cost of the link AB becomes zero. As mentioned above, the tail end node of a subject link being searched whose cost becomes zero due to subtraction is a reached node. Accordingly, the node B becomes a next reached node and, as shown in FIG. 5C, the reached node flag “1” is assigned to the element AB in the path matrix MR.

Also, out of the link costs included in the network matrix MN, the link costs of links that have the reached nodes as their tail end nodes are changed to the value that indicates that such links are to be excluded from further searches. As shown in FIG. 6B, the costs of the links AB, CB, and DB that have the reached node B as their tail end node are set at infinity to indicate that such link costs are to be excluded from searches.

Out of the link costs produced after subtraction, the values aside from zero (where zeros indicate reached node or nodes) indicate links to be subjected to a continued search. In addition, the link costs of links that have reached nodes as their root end nodes are added as links to be searched. Accordingly, in this example, the link costs of links that have node A, node B, or node C, which have been assigned the reached node flag “1” in the path matrix MR, as their root end nodes are the costs of links subjected to the next search.

Next, the lowest value “2” out of the link costs of the subject links is subtracted from the link costs. As a result, as shown in FIG. 7B, the cost of the link CD becomes zero. As mentioned above, the tail end node of a link out of the subject links being searched whose cost becomes zero due to subtraction is a reached node. Accordingly, the node D is the next reached node and, as shown in FIG. 7C, the reached node flag “1” is assigned to the element CD in the path matrix MR.

Also, out of the link costs included in the network matrix MN, the costs of links that have reached nodes as their tail end nodes are changed to the value that indicates that such links are to be excluded from searches. This means that as shown in FIG. 8B, the link costs of the links BD and CD that have the reached node D as their tail end node are set at infinity to indicate that such links are to be excluded from searches. As a result, the all link costs included in the network matrix MN become excluded from searches, meaning that all of the shortest paths that reach other nodes from the starting node A have been found.

In this algorithm, the lowest cost out of the link costs of the subject links being searched is subtracted from such link costs. Accordingly, the link cost of at least one link becomes zero, so that at least one reached node is found by each subtraction. This means that regardless of the magnitudes of the link costs, it is possible to find all of the shortest paths from a starting node to other nodes included in the network by repeating the process described above a number of times equal to the number of nodes in the network aside from the starting node, or in other words, a number (Na−1) where Na is the number of nodes included in the network. Accordingly, the number of iterations of the loop process will increase substantially in proportion to the total number of nodes at most. If the number of nodes included in a network to be searched is determined or known, since it will definitely be possible to find the shortest paths from the starting node to the other nodes by carrying out (Na−1) iterations, as described earlier it is not actually necessary to confirm whether every element in the network matrix has been set at infinity.

On the other hand, it is also possible to use an algorithm that subtracts the smallest unit for expressing link costs from the link costs being searched. In this example, the smallest unit for the link costs is “1”, and therefore in one iteration of the loop, “1” is subtracted from the link costs of the subject links being searched. When the subtraction loop is repeated and one of the link costs reaches zero, a reached node is found. In this algorithm, the number of iterations of the loop will increase depending on the link costs.

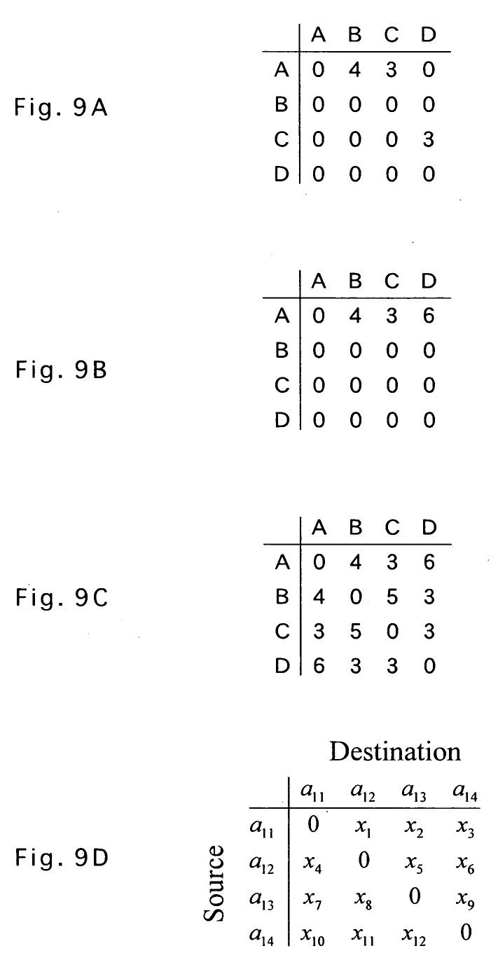

FIGS. 9A to 9D show how a lowest cost matrix MC is generated from the path matrix MR. Firstly, the path matrix MR for the starting node A is obtained (step 2-1). As shown in FIG. 9A, the costs of the various links included in the shortest paths are clear from the path matrix MR obtained in FIG. 8C and the original network matrix MN shown in FIG. 2B. Accordingly, as shown in FIG. 9B, by tracing the reached nodes to find the lowest cost from the starting node A to the other nodes, the elements in the row of the lowest cost matrix MC that has node A as the source node are determined (step 2-2). The steps 2-1 and 2-2 are then repeated with all of the nodes shown in the network matrix MN (all of the nodes included in the network N) as the starting node. By doing so, it is possible to obtain a lowest cost matrix MC such as that shown in FIG. 9C for paths from all of the nodes to the other nodes included in the network N described by the network matrix MN(step 2-3).

FIG. 9D shows a general expression for the lowest cost matrix MC. The lowest costs x1 to x12 are obtained for the nodes a11 to a14. Accordingly, if a source node and destination node included in the network N are determined, it is possible to find the lowest cost between such nodes from the lowest cost matrix MC.

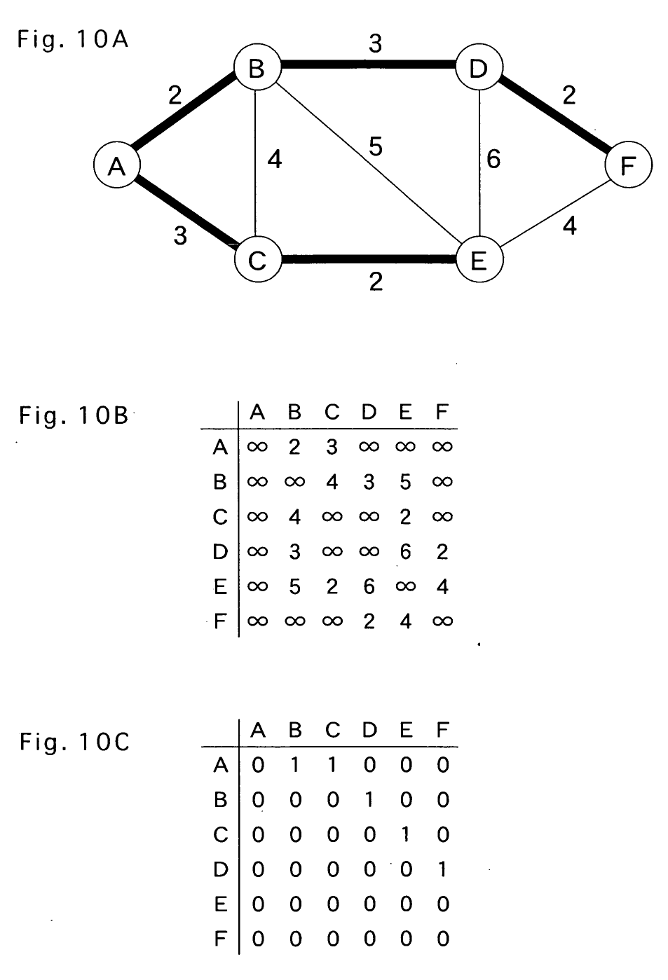

FIGS. 10A to 10C show the applying the algorithm described above on a different network. The network N shown in FIG. 10A has six nodes A to F. FIG. 10B is a network matrix MN showing the costs of links on the network N where node A is set as the starting node. FIG. 10C shows a path matrix MR that shows the shortest paths from the starting node A to other nodes, such paths having been found by carrying out steps a1 to a4 of the algorithm described above.

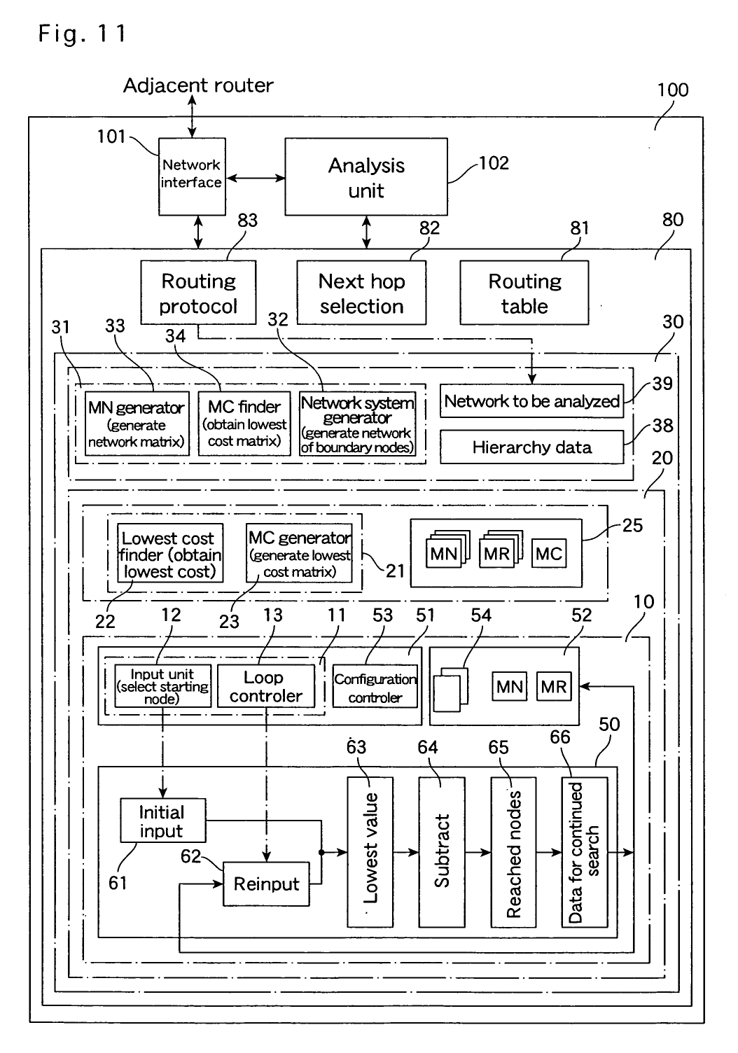

FIG. 11 schematically shows a router including a function for updating a routing table using the algorithm for searching for shortest paths described above. The router 100 is a device that constructs one node of a computer network and is equipped with suitable hardware resources, such as a CPU, a memory, and a processor whose circuits are reconfigurable, and suitable software resources for controlling the hardware resources. The router 100 includes a network interface 101 that can exchange data with an adjacent router via a suitable transfer path which may be a wired path or a wireless path, an analysis unit 102 that generates and analyzes packet data (i.e., packets) transmitted and received via the network interface 101, and a routing unit 80 equipped with a function for selecting a next hop router (i.e., the next hop) to which the packets are to be transmitted based on information in the IP headers of the packets.

The functions that realize the routing unit 80 are provided by special purpose modules (dedicated modules) or a combination of software and hardware resources that are shared with other functions, for example, the CPU or the reconfigurable processor. The routing unit 80 includes a function 82 that refers to a routing table 81 and selects the next hop to which the packets are to be transmitted. The routing unit 80 also includes a function 83 for updating the routing table 81 using a suitable routing protocol, such as OSPF, that can dynamically update a routing table, to obtain information showing the configuration (arrangement) of the network relating to routing including information of routers in the vicinity. The updating function 83 sets the network whose information obtained by the routing protocol as the network to be analyzed (subject network) and provides a lower-level analysis system 30 with a network matrix 39 generated for showing the subject network or the network information obtained for generating the network matrix 39 to carry out routing analysis. In a link-state routing algorithm such as OSPF, link information between routers is regularly exchanged by LSA (Link-State Advertisements). Accordingly, all of the link information (i.e., all of the link costs) in the subject network is known for the nodes that belong to the subject network. The network matrix 39 can therefore include link cost information in the subject network obtained by LSA.

The analysis system 30 has a hierarchical construction. The function (the third function) 31 on the highest level converts the network to be analyzed (the subject network that has been provided by a higher-level application or system) into hierarchical networks, thereby dividing the subject network into small-scale networks. The function (the second function) 21 on an intermediate level provides the lowest costs between nodes in the small-scale networks to the higher level function and thereby makes it possible to reconfigure the networks on the higher level. The function (the first function) 11 on the lowest level searches for the shortest paths between nodes in the small-scale networks and provides the shortest paths to the higher level function, thereby making it possible to calculate the lowest costs between nodes.

A first system 10 including the first function 11 on the lowest level is equipped with a processor 50 in which a plurality of circuits can be reconfigured, a control unit 51 for reconfiguring, data inputting and controlling the processor 50, and a memory 52. Circuit configuration information 54 for reconfiguring the circuits is stored in the memory 52 and at appropriate timing, circuits for carrying out a path search are reconfigured in the processor 50 by a configuration control function 53 of the control unit 51. Accordingly, different circuits can be reconfigured in the processor 50 when a path search is not required, thereby making it possible for other functions to use the processor 50.

In the processor 50, a circuit 61 for initially inputting data for a path search, a circuit 62 for reinputting data for the path search, a circuit 63 for finding the lowest value, a circuit 64 for subtracting, a circuit 65 for setting which nodes have been reached, and a circuit 66 for generating data for a continued search are reconfigured. The first function 11 for controlling the circuits constructed in the processor 50 is loaded in the control unit 51 by an appropriate program. The first function 11 includes an input unit 12 having a function for initial inputting, which selects a starting node for the initial input and repeats the initial inputting into the processor 50 (the circuits configured in the processor 50) with all of the nodes shown in the network matrix MN as starting nodes, and a loop controller 13 having a function that repeats the reinputting into the processor 50 until all of the other nodes have been reached from the starting node.

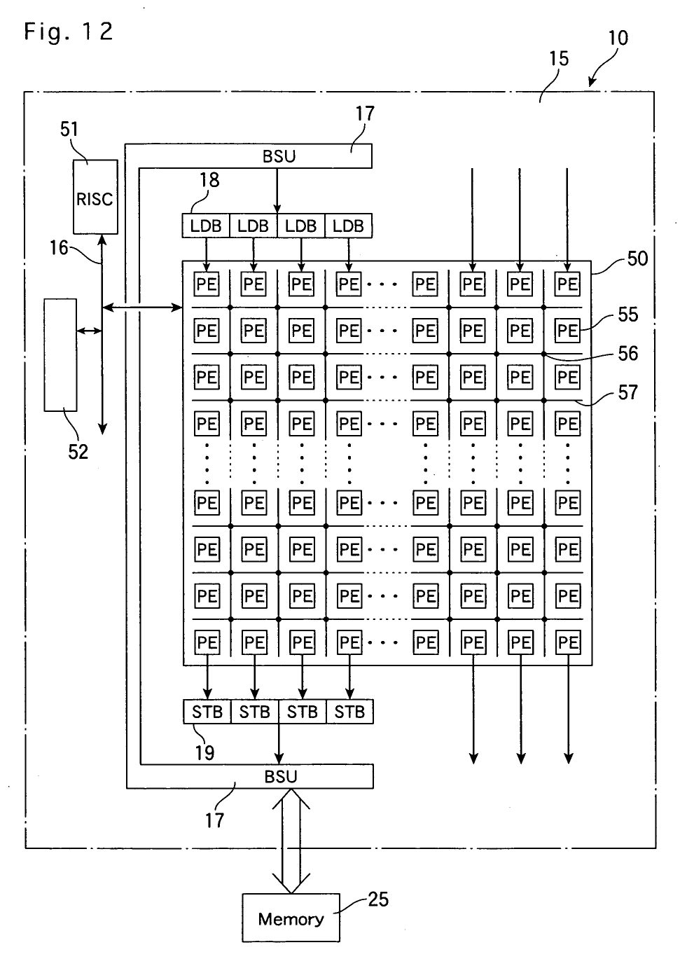

FIG. 12 shows one example of a data processing apparatus in which a first system 10 can be implemented. This data processing apparatus 15 is a DAPDNA provided by IPFlex, Inc. to which the present inventors belong. The data processing apparatus 15 is a processing unit (PU) equipped with a reconfigurable region that is the processor 50 in which circuits can be reconfigured. This data processing apparatus 15 is also an integrated circuit device where circuits are integrated on a chip. The data processing apparatus 15 includes the reconfigurable region 50, a general-purpose processor 51 such as a RISC (hereinafter simply “RISC”) with a function for reconfiguring the reconfigurable region 50, and a memory 52 that stores a program of the RISC 51 and hardware information 54 used during reconfiguration. The reconfigurable region 50 of the data processing apparatus 15 is constructed with a plurality of elements arranged in two dimensions in an array or matrix and is therefore also referred to as the “matrix”. Accordingly this matrix is used as the processor 50 where the plurality of circuits described above are configured in the present embodiment. The matrix 50 includes a plurality of processing elements (PE) 55 disposed in two dimensions, i.e., vertically and horizontally, wires 57 disposed between the processing elements 55 in a grid, and switching units 56 that freely switch the connections between vertical and horizontal wires 57 at the intersection points of the wires 57.

Typical elements of PE 55 for constructing the reconfigurable processor 50 are elements whose functions can be freely set using look-up tables respectively. Elements with internal data-paths suited to special functions or processing, such as elements for arithmetic/logic operations, delay elements, memory elements, elements for generating addresses for inputting or outputting data, and elements for inputting or outputting data, are arranged in the matrix 50 of the data processing apparatus 15. By arranging elements that are roughly divided into functional groups, it is possible to reduce redundancy, so that the AC characteristics and processing speed can be improved.

More specifically, the DAPDNA matrix 50 includes 368 PE 55, and by carrying out program control of the RISC 51, configuration data is supplied to the respective PE 55 from the RISC 51 or the memory 52 via a control bus 16. The functions of the respective PE 55 and the connections by the wire groups 57 are controlled using the configuration data, and by doing so a variety of data flows (data paths) can be freely constructed on the matrix 50. Accordingly, the matrix 50 is the one of the reconfigurable processor, in which the circuits using the PE 55 can be freely changed by the program.

To connect the matrix 50 to the periphery, such as to an external memory 25, and input and output the data to be processed, the data processing apparatus 15 includes an input buffer 18, an output buffer 19, and a bus switching unit (a bus interface or BSU) 17 that functions as an access arbitration unit. The buffers 18 and 19 each include four buffer elements and function so as to manage data inputted and outputted into and from the circuits constructed in the matrix 50.

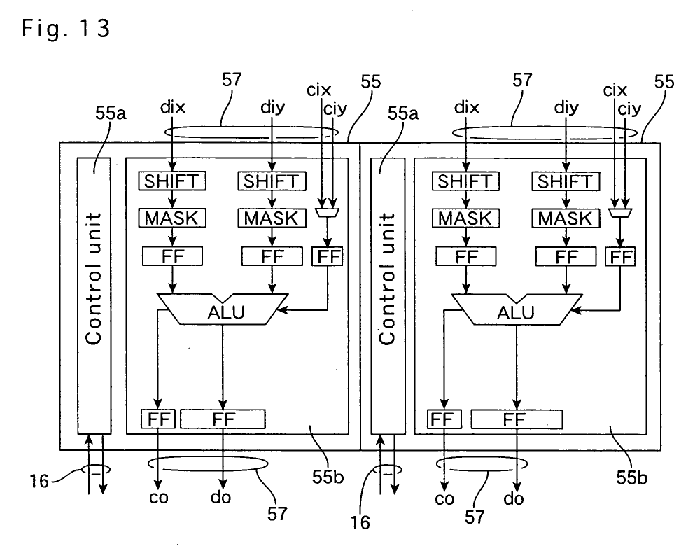

FIG. 13 shows one example of a PE 55. This PE has a construction suited to arithmetic operations and logic operations. The PE 55 includes an internal data path region 55b whose function can be changed and a control unit 55a that sets the function of the internal data path region 55b. The internal data path region 55b includes shift circuits (SHIFT) and mask circuits (MASK) for extracting desired input data from the wires 57, input registers (FF) for latching the input data dix and diy using a clock signal, an arithmetic logic unit (ALU), and an output register (FF) for latching the output data do outputted from the wires 57 using the clock signal.

The control unit 55a of each PE receives configuration data from the RISC 51 via the control bus 16 and controls the configuration of the internal data path region 55b. Accordingly, in the PE 55, the states of the shift circuits, the mask circuits, and the arithmetic logic unit are set by the control unit 55a so that various types of arithmetic operations and logic operations can be performed. The PE 55 respectively also include input registers for latching (setting) input data according to the clock signal and the output register for latching (setting) output data according to the clock signal. This means that once the content of processing, calculation or function to be performed by the PE 55 has been determined, the latency until the inputted data is subjected to calculation and outputted is determined. Accordingly, it is possible to easily arrange circuits of a pipeline processing by connecting a plurality of PE 55 using the wires 57 and thereby provide the circuits with a large throughput.

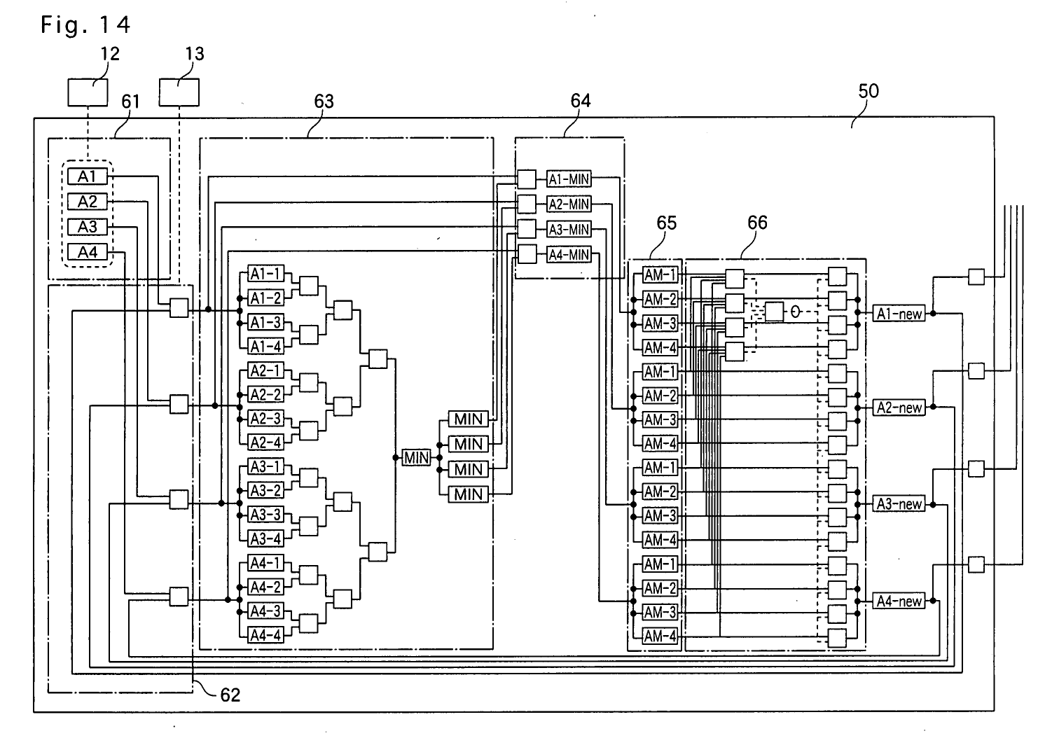

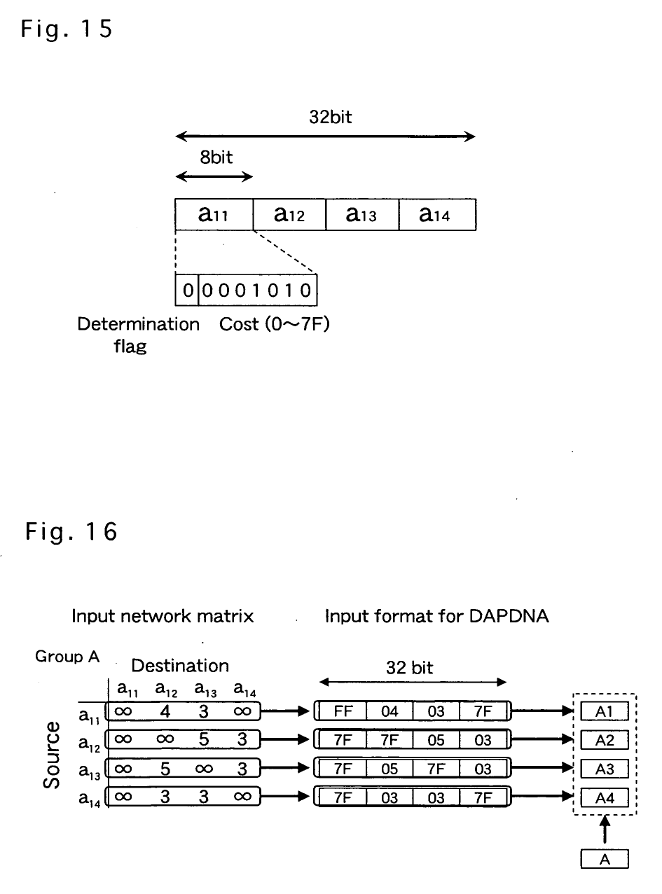

FIG. 14 schematically shows circuits that have been configured in the matrix (reconfigurable processor) 50. A circuit 61, which is the circuit for initially inputting of data for a path search, inputs four parallel data sets A1 to A4 that express a 4×4 network matrix MN where one row (one of the four parallel data sets A1 to A4) is a 32 bits data set. As shown in FIG. 15, the 32 bits of data for one row are divided into four 8-bit pieces to express four elements (per each node) on the row. Out of each eight-bit piece, the first bit (leading bit) is used as a determination flag to show whether the shortest path has been determined. These determination flags represent the path matrix MR. Accordingly, the four parallel data sets A1 to A4 include information of the network matrix MN and information of the path matrix MR, and therefore a path search on the processor 50 can be controlled using the data sets A1 to A4. The value infinity showing data that is to be excluded from searches is expressed by “7F” in hexadecimal. In addition, links that have root nodes assigned by the determination flag, that is, the rows of assigned root nodes are subjected to the searches.

FIG. 16 shows how the network matrix MN shown in FIG. 2B for a path search with node A as the starting node is converted into the suitable format for input into the processor 50. Hereinafter, the data sets A1 to A4 for a path search with node A as the starting node is indicated as “larger data set A”. The input unit 12 of the first system 10 includes the function for initial inputting and repeating the initial input . The input unit 12, firstly, sets the determination flag at the leading bit of data set A1 showing the node A at “1” to node A as the starting node and inputs the larger data set A in the circuit 61 as the initial input. This means that at the initial input stage, although all of the data sets A1 to A4 are supplied to the processor 50, only the data set A1 is used in the first path search.

The circuit 62 shown in FIG. 14 for reinputting data for a path search switches between data from the circuit 61 for the initial input (i.e., “initial data”) and data fed back from the output of the circuits configured in the processor 50 for a continued search (i.e., “reinputted data”) and supplies the selected data to the circuit 63. In the reinputted data, the determination flag at the leading bit of the data pieces representing one of the nodes will have been newly set at “1” to indicate that such node is a reached node, and the link costs of links that have such reached node as the root end node are included as the subject link costs to be newly (continuous) searched. In the present embodiment, only the data set A1 is initially used in the path search and is processed in the path search process carried out by the next circuits 63 to 66. In the next iteration of the loop, the data sets A1 and A3 is subjected to processing, in the following iteration, the data sets A1, A2 and A3 is subjected to processing, and in the final iteration, the data sets A1 to A4 is subjected to processing.

In the circuit 63 for finding the lowest value, the lowest value out of the data pieces showing the links costs to be processed for searching out of the data sets A1 to A4 is detected by a knockout method. In the circuit 64 for subtraction, the found lowest value is subtracted from every data pieces to be processed for the searching included in the data sets A1 to A4. Cost values, which is the data pieces, set at infinity (“7F”) are not subjected to this operation. In the circuit 65 for setting a reached node, the determination flag on the leading bit of the data piece whose link cost has become zero is set at “1” to show which node has been reached.

The circuit 66 for generating data for a continued search includes circuit for changing the data pieces (link costs) included in the data sets A1 to A4. In the circuit for changing, the link costs of links that have tail end nodes whose determination flag (that is the determination flag of one of the data pieces showing the link costs of links having such tail end node) has been set at “1” are all set at infinity to exclude such link costs from further processing for searches. That is, by the circuit for changing, the link costs in the column of the node with the reached flag (the determination flag is “1”) of the network matrix MN are changed to infinity. The circuit 66 also includes circuit for setting values after the subtracting of link costs of the subject links whose link costs do not become zero due to the subtracting as link costs of links for a continued search. Therefore, from the circuit 66, data sets A1 to A4 (new data sets A1 to A4) including the link costs set at infinity for the reached node and the link costs after subtraction of the other links are outputted.

These new data sets A1 to A4 are supplied to the re-input circuit 62 and at appropriate timing are supplied again to the circuit 63 that detects the lowest value. The process is repeated a predetermined number of times and the data sets where all of the link costs are infinity gather in the memory 52. The determination flags of the data sets are used as the path matrix MR that shows the shortest paths. The functions of the circuit 61 for initial inputting and the circuit 62 for reinputting data can also be realized by software. For example, a process can be carried out using software control that stores the new data sets outputted from the circuit 66 for generating data for a continued search temporarily in the memory 52 and reinput at appropriate timing that does not cause the pipeline to fail. Alternatively, if the reconfigurable processor 50 is used by other functions according to time sharing, the circuits for carrying out a path search can be reconfigured at timing that does not adversely affect execution of the other functions and the path search can be continued by inputting the reinputted data using software control.

In the processor 50, a large number of processing elements PE 55 are provided and by using such PE 55, it is possible to construct circuits for processing a plurality of data sets in parallel. A 4×4 matrix is used in the present specification and current DAPDNA are arranged for processing 32-bit input data sets. So, by dividing the 32 bits data set into four 8-bit pieces, the data sets representing the 4×4 matrix are generated. Alternatively, by configuring circuits in DAPDNA for processing the inputting sixteen of such 32-bit data sets, which each has four data pieces, parallel processing can be carried out for link costs included in an 8×8 network matrix MN. Also, as described earlier, the elements PE that are provided in the DAPDNA operate in synchronization with the clock and in each PE, FF (flip-flops) for latching data in synchronization with the clock are disposed at the input and/or output ends. Accordingly, circuits that fundamentally carry out pipeline processing are constructed in the DAPDNA, thereby making it possible to carry out the processing of the path search described above by pipeline processing.

With Dijkstra's algorithm, a calculation carried out at a given point in time is affected by the preceding calculation results, and therefore Dijkstra's algorithm is not suited to a parallel reconfigurable processor such as a DAPDNA. In addition, when Dijkstra's algorithm is installed in a data flow machine, since there is dependency between loop iterations, a long feedback loop is required, thereby reducing the throughput of the processing. In addition, since searching for lists takes time, Dijkstra's algorithm is not a shortest path searching algorithm suited to a parallel data flow machine.

Unlike Dijkstra's algorithm, in one iteration of processing by the shortest path searching algorithm included in the present invention, the present position is advanced along every branch by the distance (i.e., link cost) of the node with the lowest link cost and at least one reached node is found. Accordingly, the inventors have named this shortest path searching algorithm an “AMPSA” (Advanced-Multi-route Parallel Search Algorithm). As described earlier, the algorithm included in the present invention may use a method where in one iteration of processing, the present position is advanced by one cost unit on every branch starting from a starting node and the path where the present position first reaches another node is set as the shortest path. The inventors have named this algorithm an “MPSA” (Multi-route Parallel Search Algorithm). With MPSA, when the present position has reached a node, the present position is thereafter also advanced on the branches that extend from such reached node, and the processing ends when the present position has reached every node.

AMPSA and MPSA are algorithms that suppress the dependency of the processing and can carry out a search simultaneously on a plurality of paths, and therefore are suited to parallel processing. MPSA and AMPSA can also be expressed as a matrix calculation. As described later, this matrix calculation algorithm is scalable to a larger network. When AMPSA that subtracts the lowest value is executed on a DAPDNA, the number of clock cycles consumed for the execution of the algorithm will not depend on the link cost of the path from the starting node to the furthest node, and, when searches are carried out for every node out of n nodes with a lattice-like mesh topology, is O(n). Accordingly, with AMPSA, compared to Dijkstra's algorithm, the amount by which the calculation load increases relative to an increase in the number of nodes is extremely small.

The amount of calculation with Dijkstra's algorithm is O(n²) for a number n of nodes, so that when all the nodes are searched, the amount of calculation is O(n³). This means that with Dijkstra's algorithm, when the scale of the network increases, there is a sudden increase in the amount of calculation, which makes a large amount of CPU power and memory necessary. Also, recently, since the finding a shortest path becomes more complicated by considering a plurality of information such as the bandwidth and the wavelength and it is necessary with a normal serial processor to calculate the shortest paths separately, there is a large increase in calculation time. A combination of the AMPSA or MPSA included in the present invention and a parallel reconfigurable processor like DAPDNA can solve this problem. In addition, with a schedule where the routing table is updated once every few minutes or several times an hour, the parallel reconfigurable processor like DAPDNA can be utilized for other network processing, for example, finding best matches for IP addresses, which means that the present system is also suited to making effective use of hardware resources.

As described above, the combination of the AMPSA or MPSA included in the present invention and a synchronous parallel processor like DAPDNA is capable of independent calculation by pipeline processing. That is, even for the same network, AMPSA or MPSA can carry out processing for finding shortest paths independently for different starting nodes. In addition, the DAPDNA can process data by pipeline processing in element units and in units of single clock cycles. Accordingly, the combination of the AMPSA or MPSA and DAPDNA has a large throughput which makes it possible to carry out a shortest path search for multiple (n) starting nodes in substantially the same calculation time as that of a shortest path search for a single starting node.

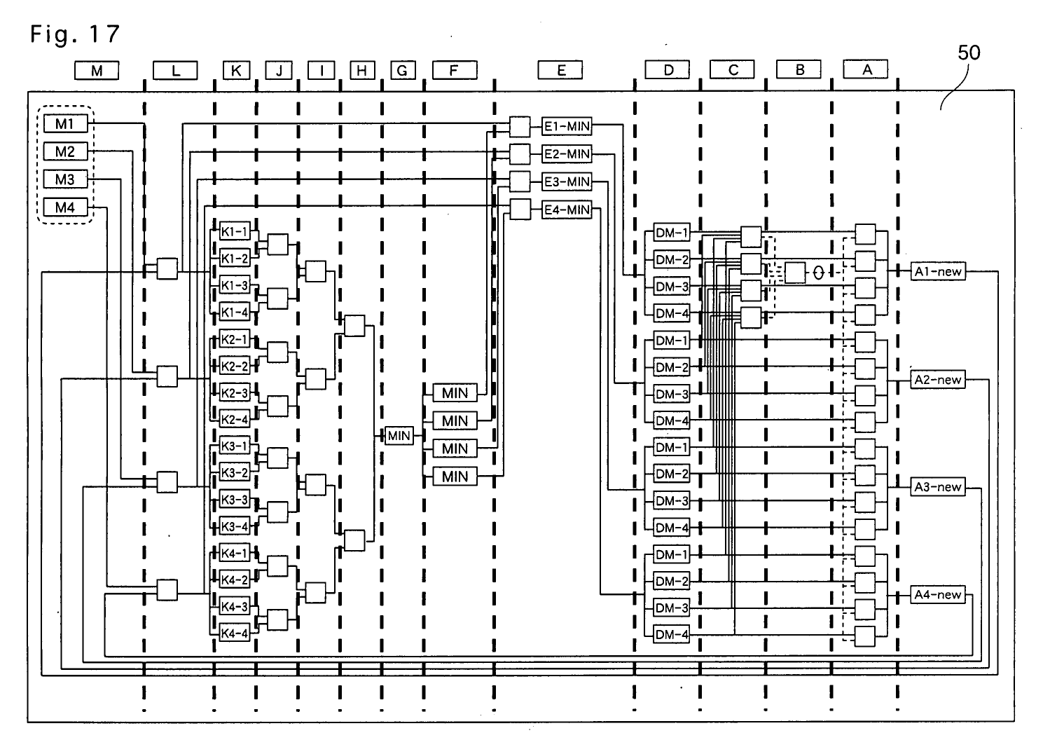

For ease of understanding the present invention, FIG. 17 shows how pipeline processing is carried out in element units of the DAPDNA. It should be noted that, as mentioned above, in the DAPDNA, same pipeline processing can be performed in units of clock cycles in addition to the units of elements, in actually, therefore, the amount of multiplication of pipeline processing is far beyond the case that is explained referring to FIG. 17. Following larger data set A that has node A as the starting node, larger data set B that has node B as the starting node, larger data set C that has node C as the starting node, and larger data set D that has node D as the starting node are processed by pipeline processing. Following this, it is also possible to carry out a shortest path search for a plurality of networks, such as by carrying out processing for larger data set E that has node E as a starting point in another network using its network matrix. Unless the combination of data sets, such as sets A1-A4, that constructs a larger data set, such as set A, changes, there is no particular significance to the order of larger data sets such as A, B, and C. Therefore, it is also possible to supply data sets with different starting nodes randomly to the circuits configured in the processor 50 and to carry out path searches independently.

In more detail, when carrying out a shortest path search for a network with an 8×8 network matrix using a DAPDNA, although it depends on the circuit construction, around 480 clock cycles are consumed per larger data set. Normally, when searching for shortest paths for all nodes, a total of “480 clock cycles×the number of nodes” will be consumed. However, by using pipeline processing configured in the DAPDNA, results are consecutively outputted in units of clock cycles, therefore, for a network that has 8 nodes and an 8×8 network matrix, when carrying out shortest path searches for all the nodes in the network, that is, when finding shortest paths that have all of the nodes as starting nodes and reach all of the other nodes, a total of only 487 (=480+8−1) clock cycles are consumed. In addition, a plurality of networks can be processed using the same pipeline processing. For example, it is possible to complete shortest path searches for all nodes in three networks, each of which has 8 nodes, in a total of 503 (480+8+8+8−1) clock cycles.

When the number of network groups increases, the number of inputted network matrices also increases. If an amount of data sets for inputting the network matrices consecutively is beyond the 480 or more clock cycles that are required to pass the shortest path search circuits configured, it will not be possible to advance to the second iteration carried out on the first data set until all of the initial inputting has been completed. In this case, the first data set may be stored in a memory and/or the pipeline configured in a DAPDNA may be extended, or, to extend the pipeline, a plurality of groups of circuits and/or a plurality of processors (DAPDNAs) may be serially connected. It is also possible to configure a plurality of groups of circuits and/or connect a plurality of processors in parallel to increase the parallelism.

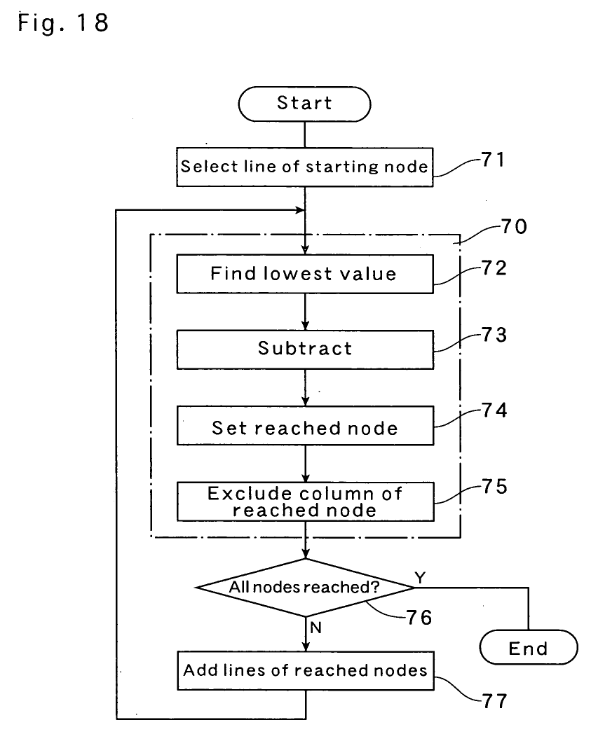

FIG. 18 is a flowchart of an algorithm (the first process) for the shortest path search in the first system 10. In step 71, using the circuit 61, the input unit 12 selects elements of the row (line) of the starting node in the network matrix MN as the link costs of the subject links for a search. In step 72, the circuit 63 finds a lowest value among the link costs included on the line being searched. In step 73, the circuit 64 subtracts the lowest value from the link costs included on the line being searched. In step 74, the circuit 65 sets node (nodes) that is a tail end node of link whose link cost has become zero as a reached node. In step 74, in circuit 66, two or more nodes that are tail end nodes of links whose link costs have become zero may be set as reached nodes. In step 75, the circuit 66 also sets the link costs of links that have the reached node as their tail end nodes, that is, the link costs in the column of the reached node as excluded from further search (i.e., the system 10 sets such link costs at infinity). In step 75, the link costs in two or more columns of the reached nodes may be excluded from further search when two or more reached nodes are found in the step 74. In step 76, if all of the nodes have been reached, the first process ends the search for the shortest paths for all of the other nodes from the starting node. If all of the nodes have not been reached, in step 77, using the circuit 62, the loop controller 13 sets the link costs of the links that were searched at the values after subtraction and adds link costs of links that have the reached nodes as root end nodes, that is, the link costs on the row or rows of the reached node or nodes, to the links to be searched. The process then returns to step 72 and finds the lowest value out of the link costs included on the lines being searched.

In this way, the first process of the first system 10 includes steps 71 to 77. Out of these steps, at least steps 72 to 75 should preferably be carried out by parallel processing by a parallel processor like a DAPDNA. That is, the process 70 including finding a lowest value (step 72) to outputting the link costs for a continuous search (step 75) can be carried out in parallel for all of the link costs included in a larger data set using a parallel processor. Also, by processing all of the link costs included in a larger data set in parallel using a parallel processor, it is possible to use pipeline processing and to obtain a large throughput.

As shown in FIG. 11, a second system 20, which includes the first system 10 and a function (the “second function”) on an intermediate level that finds a lowest cost matrix MC corresponding to a network matrix MN supplied to the second system 20 and provides a higher level function with the lowest cost matrix MC. The lowest cost matrix MC can be used in a variety of ways, and one way is to provide lowest costs between nodes on small-scale networks to a higher level to make it possible to reconfigure a network at the higher level.

The second system 20 includes a memory 25 for storing the network matrix MN that is provided to the first system 10, the path matrix MR obtained from the first system 10, and the lowest cost matrix MC. The second function 21 of system 20 includes a lowest cost finder (cost finder) 22 having a function for calculating, using the network matrix MN and the path matrix MR, the lowest costs from a given starting node to other nodes, and an MC generator 23 having a function for generating the lowest cost matrix MC including the lowest cost from each node to every other node by repeating the process described above with all of the nodes included in the network matrix as starting nodes. The method of generating the lowest cost matrix MC is the same as described earlier with reference to FIG. 9.

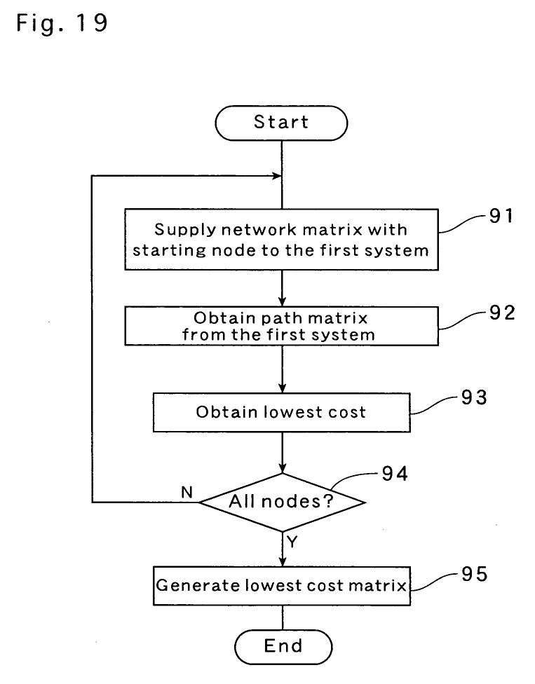

FIG. 19 is a flowchart showing a process (the “second process”) for generating the lowest cost matrix MC in the second system 20. In step 91, the cost finder 22 supplies the network matrix MN with an indication of the starting node to the first system 10. By the first process, the first system 10 searches for the shortest paths that reach other nodes from the starting node and generates the path matrix MR. In step 92, when the cost finder 22 obtains the path matrix MR from the first system 10, in step 93, the cost finder 22 calculates the lowest costs from the starting node as a source node to the other nodes as destination nodes. In step 94, the process described above is repeated until the path matrix MR that has all of the nodes included in the network represented by the network matrix MN as starting nodes is obtained. In step 95, when the path matrix MR for all of the nodes included in the network of the matrix MN as starting nodes are obtained, the MC generator 23 generates the lowest cost matrix MC including the lowest costs from each node included in the network of the matrix MN to all of the other nodes.

Note that although the second process is shown in FIG. 19 by a flowchart that includes a loop, network matrices MN with different starting nodes can be processed independently by the first system 10. Accordingly, in step 91, different network matrices MN should preferably be consecutively supplied to the first system 10 without waiting for a path matrix MR to be obtained so that pipeline processing can be carried out in the first system 10.

As shown in FIG. 11, a third system 30, which includes the second system 20 and a function (the “third function”) 31 on the high level, can carry out finding a shortest path in a large-scale network by dividing the large-scale network in to small-scale networks hierarchically for which lowest cost matrix MC can be obtained by the second system 20. Typical larger-scale network is a network (subject network) 39 to be analyzed generated from information on a network gathered by a routing protocol 83. The third function 31 of system 30 includes a hierarchical network system generator (network system generator) 32 having a function for expressing the large-scale network 39 as a combination of smaller-scale networks by dividing the large-scale network 39 into a plurality of groups to create a hierarchy. The third function 31 also includes an MN generator 33 having a function for generating the network matrices MN for such small-scale networks. In addition, the third function 31 includes an MC finder 34 having a function for finding the lowest cost matrices MC corresponding to such network matrices MN using the second system 20 with pipeline processing at high speed.

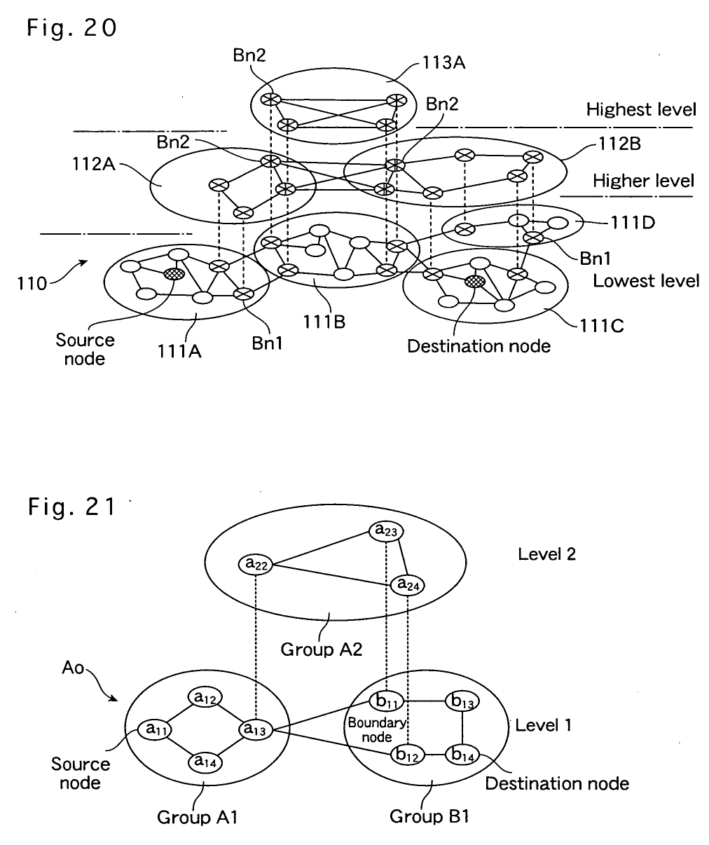

FIG. 20 schematically shows how a network is grouped and divided into multiple levels (layers or classes). First, the subject network 110 having n nodes is divided into groups of nodes (hereinafter groups) 111A to 111D with a maximum of m nodes each. The present embodiment has a premise that processing is carried out by a DAPDNA and therefore the network is divided into groups, each of which has a maximum of eight nodes. These groups 111A to 111D corresponding to the small scale networks and parts of the subject network 110 respectively and form a group of networks on the lowest level (lowest layer or lowest class).

Nodes that make links for connecting (directly connecting) across groups are called boundary nodes Bn and the boundary nodes Bn in all of the groups are extracted. When the number of extracted boundary nodes Bn is greater than m, the division into groups is repeated to make one or more intermediate levels (layers). By repeating this process, as shown in FIG. 20, a hierarchical structure of the small-scale networks generated for expressing the large-scale network by the groups of networks on multiple levels (layers) and each network on each level has maximum m nodes. The groups (networks) 112A and 112B on the higher level have only boundary nodes Bn included in groups (networks) on lower levels and have abstractions of networks on the lower levels expressed by these boundary nodes. If the number of boundary nodes Bn on the higher level is m or below, a group (network) 113A that has such boundary nodes becomes the network on the highest level. Finding the shortest paths using the network matrix of the group 113A, it is possible to find the shortest paths on the large-scale network.

Carrying out processing after dividing the large-scale network constructed having the n nodes into small-scale networks having m nodes is also effective in reducing the amount of calculation by using the locality of the connections on the network. That is, the network matrix of a large-scale network having n nodes includes n by n elements. However, since every node will not be connected to all other (n−1) nodes, most of the link costs of the elements included in the network matrix will be infinity showing that the nodes are not connected. By dividing into small-scale networks, it is possible to reflect the links between local nodes efficiently in the network matrices of the small-scale networks, thereby reducing the amount of data to be processing. Accordingly, the scale of the hardware required to carry out the search for shortest paths can be reduced and the processing time can also be reduced.

FIG. 21 shows a simplified example for explaining the present invention. By the network system generator 32, the 8-node network A0 has been divided into the 4-node groups A1 and B1 and the group A2 has been generated from the boundary nodes of such groups A1 and B1. In this example, the network is expressed on two levels (layers).

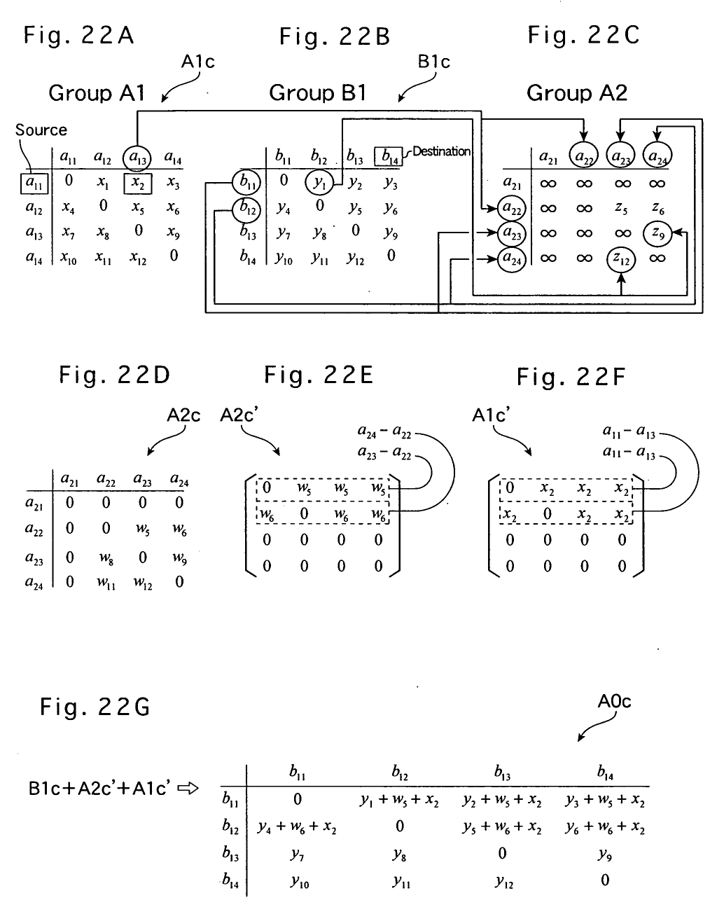

Here, consider the case when finding a shortest path from node all belonging to group A1 as a source node to node b14 belonging to group B1 as a destination node. As shown in FIGS. 22A to 22G, the processing can proceed as follows.

Step 1—The MN generator 33 generates the network matrix of the group A1 on the lowest level. The MC finder 34 supplies the network matrix to the second system 20 and obtains the lowest cost matrix A1c for the group A1 (see FIG. 22A).

Step 2—The MN generator 33 generates the network matrix of the group B1 on the lowest level. The MC finder 34 supplies the network matrix to the second system 20 and obtains the lowest cost matrix B1c for the group B1 (see FIG. 22B).

Step 3—The MN generator 33 generates the network matrix of the group A2 on the higher level (this case the highest level) that includes the boundary nodes a22, a23, and a24 that make links for connecting the group A1 and the group B1 (see FIG. 22C). The node a21 is the node a13 included in the group A1 and the nodes a23 and a24 are the nodes b11 and b12 included in the group B1 respectively. The link cost z9 (z12) between the boundary node a23 and the boundary node a24 included in the group A2 is the lowest cost y1 (y4) from the node b11 to the node b12 included in the lowest cost matrix B1c of the group B1 calculated earlier. The link cost z5 between the boundary node a22 and the boundary node a23 and the link cost z6 between the boundary node a22 and the boundary node a24 are supplied as information for the original network (subject network) A0 being analyzed.

Step 4—The MC finder 34 obtains the lowest cost matrix A2c for the higher level group A2 (see FIG. 22D) by supplying the network matrix of the group A2 generated in the above step 3 to the second system 20.

Step 5—From the lowest cost matrix A2c of the group A2, the MC finder 34 further generates the matrix A2c′ for adding the lowest costs of the paths between the boundary nodes included in the groups A1 and B1 to the lowest costs of the paths between the boundary nodes and the destination node included in the group B1. That is, the matrix A2c′ is generated for adding the lowest costs w5 and w6 of the paths between the boundary node a22 (a13) included in the group A1 and the boundary node a23 (b11) and the boundary node a24 (b12) included in the group B1 that includes the destination node b14 (see FIG. 22E). From the lowest cost matrix A1c of the group A1 that includes the source node a11, the third function 31 generates the matrix A1c′ for adding the lowest cost x2 from the boundary node a13 (a22) included in the group A1 to the source node all (see FIG. 22F).

Step 6—The MC finder 34 adds the matrices A2c′ and A1c′ to the lowest cost matrix B1c of the group B1. By doing so, the cost matrix A0c including link costs for every path from the source node a13 to the every nodes included in the group B1 via the boundary nodes a22, a23, and a24 is generated (see FIG. 22G).

Step 7—For the destination node b14, the cost (y3+w5+x2) of the path via the boundary node a23 (b11) and the cost (y6+w6+x2) of the path via the boundary node a24 (b12) are compared and the path with the lower cost is selected as the shortest path from the source node all to the destination node b14. In the same way, the shortest path that has node b13 as the destination node b13 can be determined by comparing the cost (y2+w5+x2) of a path via the boundary node a23 (b11) and the cost (y5+w6+x2) of a path via the boundary node a24 (b12) included in the cost matrix A0c.

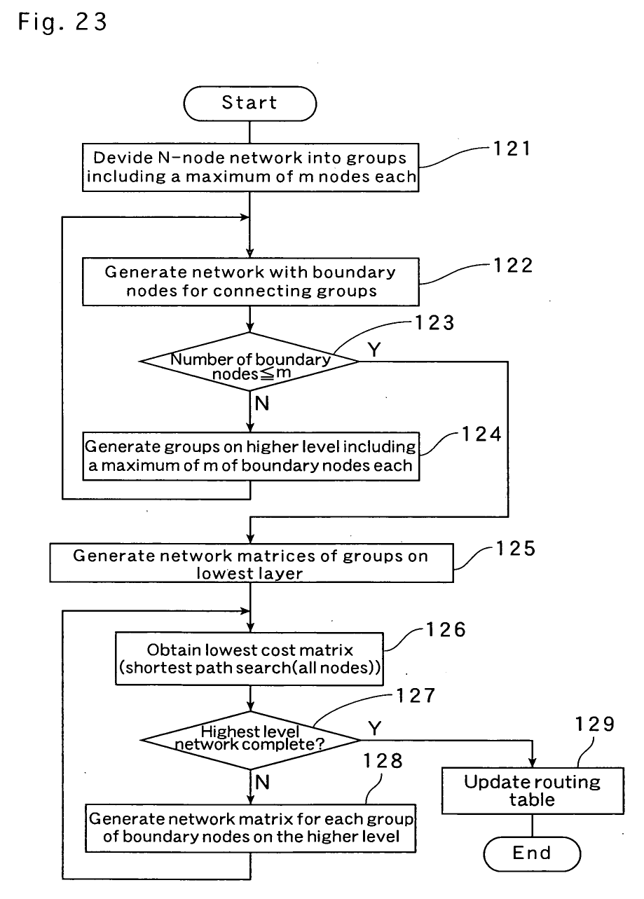

FIG. 23 is a flowchart showing the process (the “third process”) of the third system 30. First, the network system generator 32 generates networks having the boundary nodes in order to convert a large-scale network into hierarchical network system including small-scale networks. In details, in step 121, the network system generator 32 divides the subject network to be analyzed 39 into a plurality of lowest level networks (i.e., groups of nodes) where a maximum of m nodes are included in each network. In step 122, the network system generator 32 generates higher level networks from the boundary nodes associating with connections between at least two networks out of the plurality of networks on the lowest level. In step 123, the network system generator 32 completes the conversion into hierarchical network system if the total number of boundary nodes included on the higher level is equal to the maximum number m or below. If the number of boundary nodes is greater than the maximum number m in step 123, in step 124, the network system generator 32 further groups the nodes to generate a network on an even higher level. By repeating steps 122 to 124, it is possible to generate a network on a higher level including a maximum m of boundary nodes for connecting at least two networks out of the plurality of networks on the lowest level. Data produced by dividing the large-scale network into small-scale networks in a hierarchy is stored as hierarchy data 38.

Next, by using the MN generator 33 having the function that generates the network matrix and the MC finder 34 having the function that obtains the lowest cost matrix, the lowest costs are found in order from the small-scale networks on the lowest level and then the shortest paths in the large-scale network are found. In step 125, the MN generator 33 generates a network matrix MN for each of the plurality of networks on the lowest level. In step 126, the MC finder 34 supplies the respective network matrices to the second system 20 and obtains the lowest cost matrices MC. In step 127, if the lowest cost matrix MC of the highest level has been obtained, the process of system 30 is completed and the lowest cost matrix MC for the subject network 39 to be analyzed is found.

Accordingly, in step 129, the system 30 finds shortest paths that have all of the nodes included in the subject network 39 as their destination nodes and updates the routing table 81. The above method is one of methods of finding the shortest paths for each node as the destination node. That is, in the above method, for each of a plurality of paths from a source node to a destination node that pass a plurality of boundary nodes included in the higher-level networks, the total of the lowest cost from the source node to a boundary node in a network including the source node out of the plurality of networks on the lowest level, the lowest cost between the boundary nodes included in the network or networks on the higher level, and the lowest cost from a boundary node to the destination node in a network including the destination node out of the plurality of networks on the lowest level is calculated. Next, the path for which the total of the lowest costs is lowest is set as the shortest path from the source node to the destination node.

When a higher level network exists, in step 128, the MN generator 33 extracts the link costs between the boundary nodes that are used to generate the higher level network from the lowest cost matrix MC, and generates a network matrix MN for the higher level network.

When the network matrix MN has been generated, in step 126, the MC finder 34 supplies the network matrix MN to the second system 20 and obtains the lowest cost matrix MC. That is, for the higher level network, the second system 20 (the second process) obtains the lowest costs from each boundary node as a source node to the other boundary nodes.

In an alternate method of finding shortest paths with each node as the destination node, in step 128, information of the lower-level networks is included (incorporated) when the network matrix MN of a higher-level network is generated. For example, the MN generator can generate a different higher level network matrix for each destination node by expressing the lowest costs between boundary nodes on the higher level as not only the link costs for other boundary nodes on the higher level but also including the lowest cost to the source node and the destination node. That is, the lowest costs relating to the boundary nodes connecting to the source node can include the lowest cost between such boundary nodes to the source node, and the lowest costs relating to the boundary nodes connecting to the destination node can include the lowest cost between such boundary nodes to the destination node,. With this method, by finding the lowest costs of the network matrix of the highest level or by finding lowest costs of the network matrix of a higher level that includes a boundary node relating to the source node and a boundary node relating to the destination node, it is possible to find the shortest paths from the source node to the destination node.

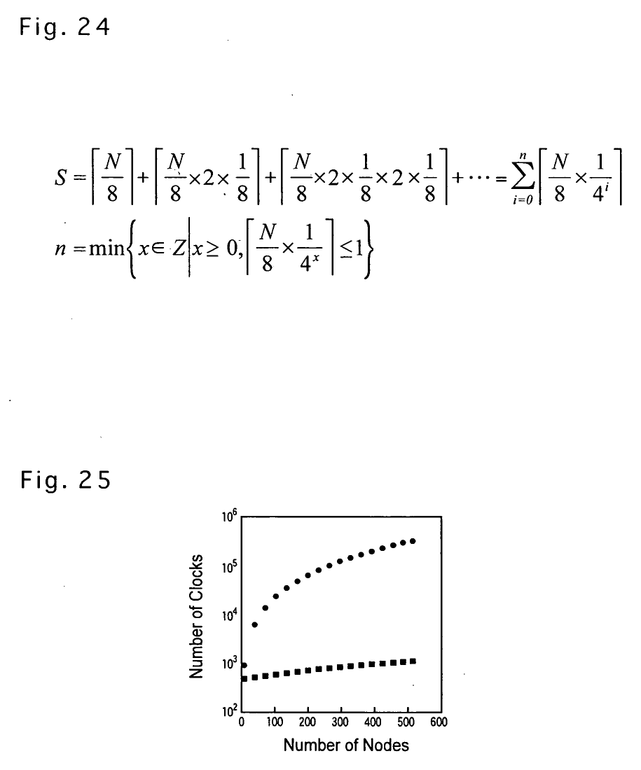

When a normal sequential processor carries out a shortest path search for n starting points, n times the calculation time for one starting point is required. On the other hand, since parallel processing is possible when the processing is carried out using a DAPDNA operating according to the algorithm included in the present invention, the calculation load hardly increases whether there is one node or n starting node. Basically, if n nodes are added, processing can be carried out with the processing time increased by n clock cycles. When the calculation circuit is designed so that calculation is carried out with 8 nodes in a group, the amount of calculation will hardly be affected by the number of nodes in each group. If there is an average of two boundary nodes per group, the number of groups S on a network of n nodes is given by the equation shown in FIG. 24. If the number of calculation clock cycles required for one starting node is “a”, the number of calculation clock cycles required for “n” starting nodes with the proposed algorithm that uses a parallel-processing processor will be (a+8S−1) compared to (n×a) with a normal serial-processing processor. This difference is clear as shown in FIG. 25, and therefore it can be understood that the method of searching for a shortest path included in the present invention becomes even more effective as the number of nodes increases.

What is claimed is:

1. A system for searching for shortest paths from a starting node to other nodes using a network matrix, the starting node and the other nodes being included in a network that has a plurality of nodes,
wherein the network matrix includes link costs of links, each link having a root end that is a node included in the network and a tail end that is another node connected to the root end node,
the system comprises a processor for configuring a plurality of circuits in the processor, the plurality of circuits including circuits for:
subtracting a first value from link costs of subject links for a search that are included in the network matrix;
setting a tail end node of a link out of the subject links whose link cost has become zero due to the subtracting as a reached node;
changing link costs of links included in the network matrix whose tail end nodes are the reached node to a value indicating exclusion from further search; and
setting values after the subtracting of link costs of the subject links whose link costs do not become zero due to the subtracting as link costs of links for a continued search, and
the system further comprises:
means for initially inputting, into the processor, link costs of links included in the network matrix and whose root end nodes are the starting node as the link costs of the subject links; and
means for reinputting, into the processor, the link costs of the links for the continued search and link costs of links, whose root end nodes are the reached node, included in the network matrix as the link costs of the subject links.

2. The system according to claim 1,
wherein the plurality of circuits configured in the processor further includes a circuit for finding a lowest value among the link costs of the subject links as the first value.

3. The system according to claim 1,
wherein the first value is a lowest unit for expressing the link costs included in the network matrix.

4. The system according to claim 1, further comprising a first function for obtaining the shortest paths from the starting node to the other nodes by repeating the reinputting into the processor until every other node reachable from the starting node has been set as a reached node.

5. The system according to claim 4,
wherein the plurality of circuits configured in the processor further includes a circuit for finding a lowest value among the link costs of the subject links as the first value, and
the first function includes repeating the reinputting into the processor a number of times equal to the number of the other nodes for the starting node that are included in the network.

6. The system according to claim 4,
wherein the first function includes repeating the initial inputting into the processor with all of the nodes included in the network as the starting node to obtain shortest paths that arrive the other nodes from every node included in the network.

7. A system for finding lowest costs from a starting node to other nodes, the starting node and the other nodes being included in a network that has a plurality of nodes, comprising:
a first system that is the system according to claim 4, and
a second function for obtaining lowest costs from the starting node to the other node by calculation using the shortest paths obtained by the first function and the link costs included in the network matrix.

8. The system according to claim 7,
wherein the second function includes obtaining shortest paths that have all of the nodes included in the network as the starting node and obtaining lowest costs from every node to other nodes that are included in the network.

9. A system comprising:
a second system that is the system according to claim 7; and
a third function for obtaining a shortest path from a source node to a destination node, the source node and the destination node being included in a subject network to be analyzed that has n nodes,
wherein the plurality of circuits configured in the processor are capable of processing the link costs of the subject links associating with a maximum of m nodes and the third function comprises:
dividing the subject network into a plurality of networks on a lowest level, each of which has a maximum of m nodes;
generating at least one network on a higher level that has a maximum of m boundary nodes, the boundary nodes making links for connecting at least two networks out of a plurality of networks on a lower level;
generating a lowest level network matrix for each of the plurality of networks on the lowest level;
obtaining a lowest cost from each node to each other node in each of the plurality of networks on the lowest level using the second function and the lowest level network matrix;
generating a higher level network matrix for each higher level network, the higher level network matrix including lowest costs from a boundary node to other boundary nodes as link costs; and
obtaining, for the higher level networks, lowest costs from each boundary node to each other boundary node using the second function and the higher level network matrix, with each boundary node as the starting node.

10. The system according to claim 9,
wherein the third function further comprises:
calculating, for each of a plurality of paths from the source node to the destination node via a plurality of the boundary nodes included in the higher-level network, a total of (i) a lowest cost from the source node to a boundary node in a network having the source node out of the plurality of lowest level networks, (ii) a lowest cost between boundary nodes included in the higher level network, and (iii) a lowest cost from a boundary node included in a network having the destination node out of the plurality of lowest level networks to the destination node; and
obtaining a path with a lowest total of the lowest costs.

11. The system according to claim 9,
further comprising a routing unit that is connected to a computer network and is equipped with functions of:
selecting a next hop to which a packet is to be transmitted based on a routing table; and
updating the routing table using the third function with obtaining information on a computer network that has the next hop using a routing protocol and recognizing the computer network as the subject network to be analyzed.

12. A method comprising searching for shortest paths from a starting node to other nodes using a processor, the starting node and the other nodes being included in a network that has a plurality of nodes,
wherein the searching comprises:
obtaining a network matrix including link costs of links, each link having a root end that is a node included in the network and a tail end that is another node connected to the root end node; and
configuring a plurality of circuits in the processor,
wherein the plurality of circuits include circuits for:
subtracting a first value from link costs of subject links for a search that are included in the network matrix;
setting a tail end node of a link out of the subject links whose link cost has become zero due to the subtracting as a reached node;
changing link costs of links included in the network matrix whose tail end nodes are the reached node to a value indicating exclusion from further search; and
setting values after the subtracting of link costs of the subject links whose link costs do not become zero due to the subtracting as link costs of links for a continued search, and
the searching further comprises:
initially inputting, into the processor, link costs of links included in the network matrix and whose root end nodes are the starting node as the link costs of the subject links; and
reinputting, into the processor, the link costs of the links for the continued search and link costs of links, whose root end nodes are the reached node, included in the network matrix as the link costs of the subject links.

13. A method comprising searching for shortest paths from a starting node to other nodes using a processor and a network matrix, the starting node and the other nodes being included in a network that has a plurality of nodes,
wherein the network matrix includes link costs of links, each link having a root end that is a node included in the network and a tail end that is another node connected to the root end node,
wherein the processor includes circuits for:
subtracting a first value from link costs of subject links for a search that are included in the network matrix;
setting a tail end node of a link out of the subject links whose link cost has become zero due to the subtracting as a reached node;
changing link costs of links included in the network matrix whose tail end nodes are the reached node to a value indicating exclusion from further search; and
setting values after the subtracting of link costs of the subject links whose link costs do not become zero due to the subtracting as link costs of links for a continued search, and
the step of searching for the shortest paths further includes:
initially inputting, into the processor, link costs of links included in the network matrix and whose root end nodes are the starting node as the link costs of the subject links; and
reinputting, into the processor, the link costs of the links for the continued search and link costs of links, whose root end nodes are the reached node, included in the network matrix as the link costs of the subject links.

14. The method according to claim 13,
wherein the step of searching for the shortest paths further comprises:
obtaining the shortest paths from the starting node to the other nodes by repeating the reinputting into the processor until every other node reachable from the starting node has been set as a reached node.

15. The method according to claim 14,
wherein the processor further includes a circuit for finding a lowest value among the link costs of the subject links as the first value,
and the step of obtaining the shortest paths includes repeating the reinputting into the processor a number of times equal to the number of the other nodes for the starting node that are included in the network.

16. The method according to claim 13,
wherein the step of searching for the shortest paths further includes repeating the initial inputting into the processor with all of the nodes included in the network as the starting node to obtain shortest paths that reach the other nodes from every node included in the network.

17. The method according to claim 14,
comprising finding lowest costs from the starting node to the other nodes included in the network,
wherein the step of finding the lowest cost includes:
obtaining shortest paths using the step of searching for the shortest paths; and obtaining the lowest costs by calculation using the shortest paths and the link costs included in the network matrix.

18. The method according to claim 17,
wherein the step of finding the lowest costs includes obtaining shortest paths that have all of the nodes included in the network as the starting node and obtaining lowest costs from the nodes included to other nodes that are in the network.

19. The method according to claim 18:
comprising obtaining a shortest path from a source node to a destination node, the source node and the destination node being included in a subject network to be analyzed that has n nodes,
wherein the circuits included in the processor are capable of processing the link cost of the subject links associating with a maximum of m nodes, and the step of obtaining the shortest path from the source node to the destination node comprises:
dividing the subject network into a plurality of networks on a lowest level, each of which has a maximum of m nodes;
generating at least one network on a higher level that has a maximum of m boundary nodes, the boundary nodes making links for connecting at least two networks out of a plurality of networks on a lower level;
generating a lowest level network matrix for each of the plurality of networks on the lowest level;
obtaining the lowest cost from each node to each other node in each of the plurality of network on the lowest level using the step of finding the lowest costs and the lowest level network matrix;
generating a higher level network matrix for each higher level network, the higher level network matrix including lowest costs from a boundary node to other boundary nodes as link costs; and
obtaining, for the higher level networks, the lowest costs from each boundary node to each other boundary node using the step of finding the lowest costs and the higher level network matrix, with each boundary node as the starting node.

20. The method according to claim 19, wherein the step of obtaining the shortest path from the source node to the destination node further comprising:
calculating, for each of a plurality of paths from the source node to the destination node via a plurality of the boundary nodes included in the higher-level network, a total of (i) a lowest cost from the source node to a boundary node in a network having the source node out of the plurality of lowest level networks, (ii) a lowest cost between boundary nodes included in the higher level network, and (iii) a lowest cost from a boundary node included in a network having the destination node out of the plurality of lowest level networks to the destination node; and
obtaining a path with a lowest total of the lowest costs.

21. A method comprising:
selecting a next hop to which a packet is to be transmitted based on a routing table; and
obtaining information on a computer network that has the next hop using a routing protocol, recognizing the computer network as a subject network to be analyzed, obtaining shortest path from a source node to a destination node according to the method according to claim 19, and updating the routing table.

22. A method of searching for shortest paths from a starting node to other nodes, the starting node and the other nodes being included in a network that has a plurality of nodes,
the method comprising:
providing a network matrix including link costs of links, each of which has a root end that is a node included in the network and a tail end that is another node connected to the root end node;
subtracting a first value from link costs of subject links for a search that are included in the network matrix;
setting a tail end node of links out of the subject links whose link cost has become zero due to the subtraction as a reached node;
changing link costs of links included in the network matrix whose tail end nodes are the reached node to a value indicating exclusion from further search; and
setting values after the subtracting of link costs of the subject links whose link costs do not become zero due to the subtracting as link costs of links for a continued search and returning to the step of subtracting with the link costs of the links for the continued search and link costs of links, whose root end nodes are the reached node, included in the network matrix, as the link costs of the subject links.

23. The method according to claim 22,
wherein the step of subtracting sets the lowest cost out of the link costs of the subject links as the first value.

24. The method according to claim 22,
wherein the step of subtracting sets the lowest unit for expressing the link costs included in the network matrix as the first value.
